(19) United States
(12) Patent Application Publication
(10) Pub. No.: US 2012/0163003 A1
(43) Pub. Date: Jun. 28, 2012

(54) LIGHT EMITTING APPARATUS

(76) Inventors: Ki Un LEE, Suwon-si (KR); Chang Sub Lee, Seoul (KR); Kyeong Ik Min, Suwon-si (KR); Hyung Jin Kim, Seoul (KR); Sang Ho Yoon, Yongin-si (KR); Kyoung Sik Choi, Seoul (KR)

(21) Appl. No.: 13/330,068

(22) Filed: Dec. 19, 2011

(30) Foreign Application Priority Data
Dec. 22, 2010 (KR) 10-2010-0132460

(51) Int. Cl. F21V 29/00

(52) U.S. Cl. 362/382

(57) ABSTRACT

A light emitting apparatus is provided. The light emitting apparatus includes a support unit configured to protrude to a front side to which light is emitted, and a heat emitting unit configured to emit heat generated by the light emission in multiple directions. According to the structure, the heat may be emitted quickly. Therefore, quality of the light emitting apparatus may be increased.

### CROSS-REFERENCE TO RELATED APPLICATION

This application claims the benefit of Korean Patent Application No. 10-2010-0132460, filed on Dec. 22, 2010, in the Korean Intellectual Property Office, the disclosure of which is incorporated herein by reference.

### BACKGROUND

1. Field

Example embodiments of the following description relate to a light emitting apparatus improved in emission efficiency, and more particularly, to a light emitting apparatus having an emission structure capable of emitting heat in multiple directions from a light emission diode (LED) package.

2. Description of the Related Art

With recent development of semiconductor technology, use of a high-performance light emitting diode (LED) is increasing. The LED is applied to various fields. For example, the LED is applied to a backlight unit of a display device, and lighting systems such as incandescent bulbs, fluorescent lamps, and road lamps.

The LED achieves long lifespan and low power consumption, thereby reducing cost for maintenance and repair. However, the LED may be deteriorated by a thermal stress. Since such a thermal stress directly deteriorates characteristics of the LED, various plans for efficient heat emission of the LED are necessitated.

### SUMMARY

According to example embodiments, there may be provided a light emitting apparatus capable of improving the performance by emitting heat generated during driving in multiple directions.

The foregoing and/or other aspects are achieved by providing a light emitting apparatus including a support unit configured to protrude to a front side to which a light is emitted, and a heat emitting unit configured to emit heat generated by the light emission, in multiple directions.

The support unit may support a light emitting unit consisting of at least one light emitting diode (LED) package.

The support unit may include a first support member, and a second support member integrally bending and extending from the first support member toward the front side.

The heat emitting unit may include a plurality of first heat emitting members mounted to the support unit to protrude to the front side, a plurality of second heat emitting members mounted to the support unit to protrude to a rear side to which light is not emitted, and at least one heat emission hole formed through the support unit to supply an air passage.

The support unit may include a plurality of first heat emitting members mounted to the support unit to protrude to the front side and to extend in a radial direction from the second support member, a plurality of second heat emitting members mounted to the support unit to protrude to a rear side to which light is not emitted, and at least one heat emission hole formed between the first support member and the second support member to supply an air passage.

The foregoing and/or other aspects are achieved by providing a light emitting apparatus including a support unit configured to protrude to a front side to which light is emitted, and a heat emitting unit configured to comprise a plurality of heat emitting members protruding to the front side to which light is emitted and a rear side to which light is not emitted, so that heat generated by the light emission is emitted in multiple directions.

The support unit may support a light emitting unit that emits light such that the light emitting unit protrudes to the front side, and the light emitting unit may include at least one light emitting diode (LED) package.

The heat emitting unit may include a plurality of first heat emitting members mounted to the support unit to protrude to the front side, a plurality of second heat emitting members mounted to the support unit to protrude to the rear side, and at least one heat emission hole formed on the support unit to supply an air passage.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates an exploded perspective view of a light emitting apparatus according to example embodiments;

FIG. 2 illustrates a rear perspective view of the light emitting apparatus of FIG. 1, seen from a rear side;

FIG. 3 illustrates a side view of the light emitting apparatus of FIG. 1, seen from one lateral side; and

FIG. 4 illustrates another side view of the light emitting apparatus of FIG. 1, seen from the other lateral side.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

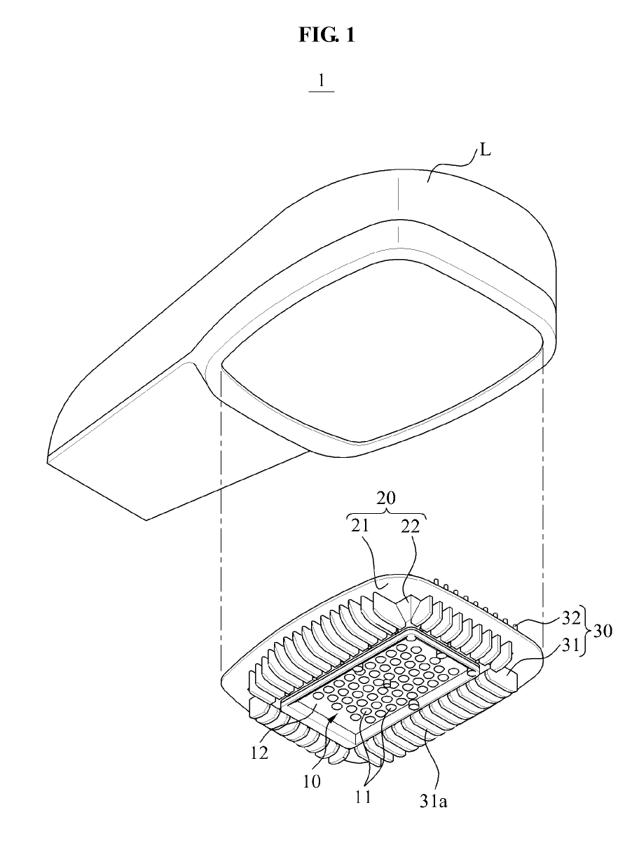

FIG. 1 illustrates an exploded perspective view of a light emitting apparatus 1 according to example embodiments.

As shown in FIG. 1, the light emitting apparatus 1 includes a light emitting unit 10, a support unit 20, and a heat emitting unit 30. In the present embodiments, the light emitting apparatus 1 will be explained as being applied to a lighting device L, such as a street light, to emit light. However, application of the light emitting apparatus 1 is not limited to the lighting device L.

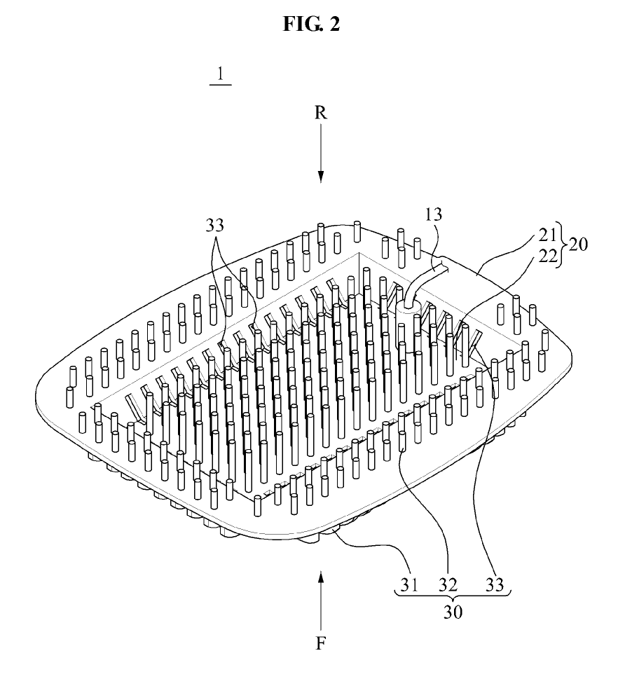

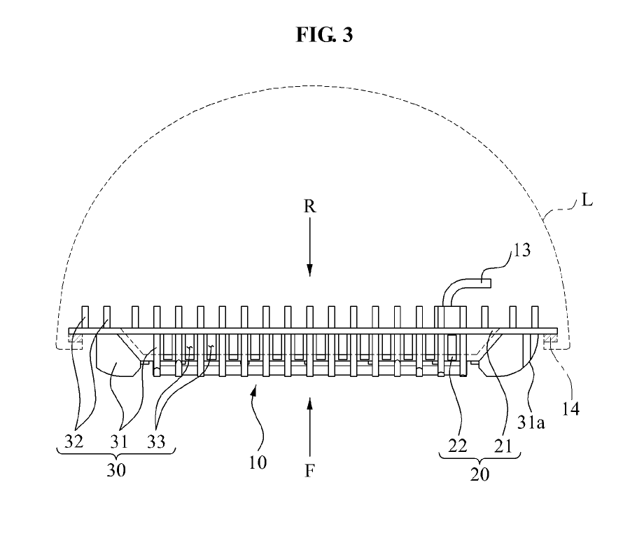

The light emitting unit 10 may include a light source 11 that generates and emits light, and a substrate 12 electrically connected to the light source 11. The light source 11 may include at least one light emitting diode (LED) package consisting of environment-friendly and energy-efficient LEDs. As shown in FIGS. 2 and 3, the substrate 12 may be applied with electricity, through being connected to a power supply line 13.

The present embodiments will be explained as that the light source 11 including a plurality of the LED packages are mounted on the substrate as shown in FIG. 1, although not limited to this structure.

The support unit 20 may support the light emitting unit 10 such that the light emitting unit 10 protrudes in a light emitting direction with respect to a mounting position of the light emitting unit 10, that is, protrudes to a front side F. The support unit 20 has a substantially rectangular plate shape. The support unit 20 may include a first support member 21 constituting a body of the light emitting apparatus 1 and a second support member 22 integrally bending from the first support member 21 to support the light emitting unit 10.

As shown in FIG. 2, more specifically, the second support member 22 may integrally bend and protrude from the first support member 21 toward the front side F to which the light is emitted. Thus, the first support member 21 and the second support member 22 are formed as an integrated body. A depressed space (not shown) is formed on a front surface of the first support member 21 and the second support member 22 being integrated, the front surface directed to the front side F. The light emitting unit 10 is fixed and supported in the depressed space (not shown) by force-fit.

According to the above configuration of the support unit 20, the light emitting unit 10 is relatively protruded and exposed to the front side F. Accordingly, an exposed surface area of the light emitting unit 10 increases, thereby enhancing emission of heat generated during driving of the light emitting unit 10.

The heat emitting unit 30 may emit the heat generated from the light emitting unit 10 in multiple directions. For this purpose, the heat emitting unit 30 may include a first heat emitting member 31, a second heat emitting member 32, and a heat emission hole 33.

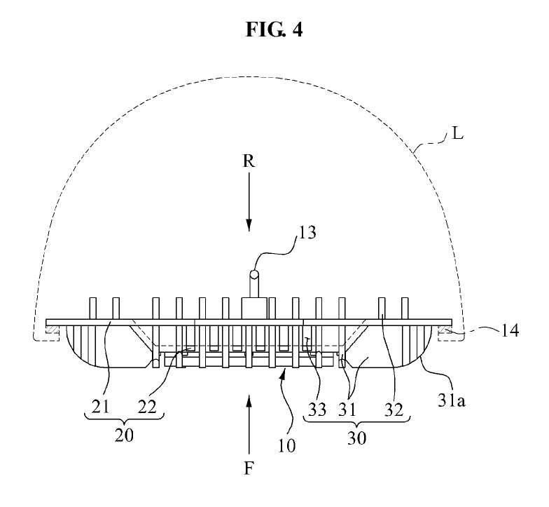

Specifically, a plurality of the first heat emitting members 31 are provided to protrude to the front side F with respect to the first support member 21. The first heat emitting members 31 may have a plate shape and protrude in a radial direction from the second support member 22 as shown in FIG. 1. A plurality of the first heat emitting members 31 may be arranged at uniform intervals with respect to the first support member 21 as shown in FIGS. 3 and 4. However, the embodiments are not limited to this structure.

Referring to FIG. 1, each of the first heat emitting members 31 may include an upper end surface 31a gently curved outward in a direction to be apart from the second support member 22 and turned toward the first support member 21. Therefore, even though the first heat emitting members 31 are exposed to the front side F, an appearance of the first heat emitting members 31 may not be deteriorated by existence of the upper end surface 31a.

A plurality of the second heat emitting member 32 may be provided, protruding to a rear side R with respect to the first support member 21 and the second support member 22. As shown in FIG. 2, the second heat emitting members 32 may have a cylindrical shape with a circular cross section and protrude from the first support member 21. Also, a plurality of the second heat emitting members 32 may be arranged at uniform intervals with respect to the first support member 21 as shown in FIGS. 3 and 4.

At least one heat emission hole 33 is disposed between the first support member 21 and the second support member 22. For example, a plurality of the heat emission holes 33 may be arranged between the first support member 21 and the second support member 22 at uniform intervals as shown in FIGS. 3 and 4. Accordingly, a passage for airflow is formed. Shape and number of the heat emission holes 33 are not specifically limited.

A heat emission operation of the light emitting apparatus 1 structured as described above will be explained with reference to FIGS. 1 through 4.

As shown in FIGS. 1 and 4, when the light emitting unit 10 installed in the predetermined lighting device L operates and emits light, heat is generated from the light emitting unit 10. The heat is emitted through the first heat emitting member 31 and the second heat emitting member 32 mounted to the support unit 20 that supports the light emitting unit 10. Here, since the first heat emitting member 31 and the second heat emitting member 32 protrude respectively toward the front side F to which the light is emitted and the rear side R to which the light is not emitted, with respect to the mounting position of the light emitting unit 10, the heat is emitted in both directions.

In addition, as shown in FIG. 2, since the plurality of the heat emission holes 33 are formed between the first support member 21 that supports the light emitting unit 10 and the second support member 22 bending from the first support member 21 and protruding to the front side F, the heat of the light emitting unit 10 is emitted also through the airflow. Here, since the plurality of the heat emission holes 33 are formed across the first heat emission member 31 and the second heat emission member 32, the airflow emits the heat in different directions from the first heat emitting member 31 and the second heat emitting member 32.

Furthermore, since the first support member 21 and the second support member 22 are protruded and exposed to the front side F, the heat of the light emitting unit 10 may also be emitted through contact with ambient air.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A light emitting apparatus comprising:
a support unit configured to protrude to a front side to which a light is emitted; and
a heat emitting unit configured to emit heat generated by the light emission, in multiple directions.

2. The light emitting apparatus of claim 1, wherein the support unit supports a light emitting unit consisting of at least one light emitting diode (LED) package.

3. The light emitting apparatus of claim 1, wherein the support unit comprises:
a first support member; and
a second support member integrally bending and extending from the first support member toward the front side.

4. The light emitting apparatus of claim 1, wherein the heat emitting unit comprises:
a plurality of first heat emitting members mounted to the support unit to protrude to the front side;
a plurality of second heat emitting members mounted to the support unit to protrude to a rear side to which light is not emitted; and
at least one heat emission hole formed through the support unit to supply an air passage.

5. The light emitting apparatus of claim 3, wherein the support unit comprises:
a plurality of first heat emitting members mounted to the support unit to protrude to the front side and to extend in a radial direction from the second support member;
a plurality of second heat emitting members mounted to the support unit to protrude to a rear side to which light is not emitted; and
at least one heat emission hole formed between the first support member and the second support member to supply an air passage.

6. A light emitting apparatus comprising:
a support unit configured to protrude to a front side to which light is emitted; and
a heat emitting unit configured to comprise a plurality of heat emitting members protruding to the front side to which light is emitted and a rear side to which light is not emitted, so that heat generated by the light emission is emitted in multiple directions.

7. The light emitting apparatus of claim 6, wherein
the support unit supports a light emitting unit that emits light such that the light emitting unit protrudes to the front side, and
the light emitting unit comprises at least one light emitting diode (LED) package.

8. The light emitting apparatus of claim 6, wherein the heat emitting unit comprises:
a plurality of first heat emitting members mounted to the support unit to protrude to the front side;
a plurality of second heat emitting members mounted to the support unit to protrude to the rear side; and
at least one heat emission hole formed on the support unit to supply an air passage.
